(19) United States
(12) Patent Application Publication
(10) Pub. No.: US 2005/0002012 A1
(43) Pub. Date: Jan. 6, 2005

(54) Stage apparatus, static pressure bearing apparatus, positioning method, exposure apparatus and method for manufacturing device

(75) Inventors: Shigeo Sakino, Tokyo (JP); Yoshimasa Fukushima, Hitachinaka (JP)

Correspondence Address: FITZPATRICK CELLA HARPER & SCINTO, 30 ROCKEFELLER PLAZA, NEW YORK, NY, 10112, US

(73) Assignees: Canon Kabushiki Kaisha, Tokyo (JP); Hitachi High-Technologies Corporation, Tokyo (JP)

(21) Appl. No.: 10/845,206

(22) Filed: May 14, 2004

(30) Foreign Application Priority Data
May 23, 2003 (JP) 2003-146754(PAT.)

(51) Int. Cl. G11B 5/027

(52) U.S. Cl. 355/75

(57) ABSTRACT

Using a conductive material having volume resistance of approximately 1E⁻³ Ω·cm or above for a movable guide 3 axially supported by a static pressure bearing 10 makes it possible to sufficiently reduce deflection of beams caused by eddy current generated due to a leaked magnetic field from an electron lens of an electron beam exposure apparatus or deflection of beams due to the influences from increased charge by secondary electrons.

### FIELD OF THE INVENTION

The present invention relates to a technology for realizing high-speed movement or precise positioning of a stage in a non-atmosphere (in vacuum, etc.) or high precision scan movement in a semiconductor exposure apparatus, electron beam drawing apparatus, precision measuring instrument, etc., used for manufacturing a semiconductor device.

### BACKGROUND OF THE INVENTION

There is a conventional stage apparatus, as shown, for example, in Japanese Patent Application Laid-Open No. 2001-153140 in which a coating layer such as TiN and TiC is provided and polished to a mirror-like finish for the purpose of increasing the degree of vacuum of a static pressure bearing used for guiding a stage in vacuum, etc., to reduce roughness on the surface of a bearing material. Furthermore, this stage apparatus provides a coating layer having non-magnetic and electrically insulating properties so as to be used for an electron beam drawing apparatus. Furthermore, there is also a stage apparatus as shown in Japanese Patent Publication No. 7-58667 in a sample holder on which a sample is placed and a stage on which the sample holder is placed are made of semi-conductive material.

However, the conventional structures include the following disadvantages. That is,

(1) Surface treatment applied to a movable guide of the bearing requires additional steps and leads to a cost increase. Finishing was only required for the movable guide previously, but applying surface treatment requires additional steps like machining of the movable guide→surface treatment→finish of surface-treated surface.

(2) When an air supply to the bearing is stopped by accident or power failure, etc., the surface-treated surface of the movable guide contacts the bearing surface of the bearing section, leading to damage of the surface of the movable guide and deteriorating bearing characteristics and degree of vacuum.

(3) The surface is coated with materials of different coefficients of thermal expansion, but the coating may fall off due to temperature variations, etc.

(4) Existence of bubbles, etc., between the movable guide and surface-treated surface causes that area to expand in vacuum, damaging the movable guide.

(5) An electron beam drawing apparatus, etc., in particular needs to use a non-magnetic substance as its material and at the same time use a relatively high resistance material to prevent beam fluctuations due to charging. An insulator is liable to fluctuations due to charging and low resistance leads to fluctuations of charge beams due to eddy current. These influences diminish as the distance from a light source increases, but as the accuracy increases, influences of movement of the stage grow to a not negligible level.

### SUMMARY OF THE INVENTION

The present invention has been implemented in view of the above described problems and it is a first object of the present invention to simplify manufacturing steps, prevent any cost increase and maintain reliability even when used in a high degree of vacuum.

It is a second object of the present invention to enhance the strength of a movable guide and bearing section and construct them using a ceramic material to thereby sufficiently increase surface hardness and reduce damages at the time of contact.

In order to solve the above described problems and attain the above described objects, modes of the present invention will be enumerated below.

[Mode 1]

A stage apparatus installed in a predetermined atmosphere, including a stage provided with a holder which holds an object for moving the holder within a predetermined plane and at least one static pressure bearing section which jets a fluid with a predetermined pressure between a movable section which moves the stage within the predetermined plane and a support section which axially supports the movable section to make the movable section neutrally float to thereby support the movable section, wherein the movable section and support section are made of a conductive material.

[Mode 2]

In the above described mode 1, the conductive material is a conductive ceramic material.

[Mode 3]

In the above described mode 2, the conductive ceramic material is silicon carbide.

[Mode 4]

In the above described mode 2, the conductive ceramic material is alumina prepared so as to have conductivity.

[Mode 5]

In the above described mode 2, the conductive ceramic material is a composite material with silicon immersed in porous silicon carbide.

[Mode 6]

In any one of the above described modes 1 to 5, the conductive material is a material having volume resistivity of at least approximately 10⁻³ Ω·cm.

[Mode 7]

In any one of the above described modes 1 to 6, the conductive material is non-magnetic substance.

[Mode 8]

A stage apparatus installed in a predetermined atmosphere, including a stage provided with a holder which holds an object for moving the holder within a predetermined plane and at least one static pressure bearing section which jets a fluid with a predetermined pressure between a movable section which moves the stage within the predetermined plane and a support section which axially supports the movable section to make the movable section neutrally float to thereby support the movable section, wherein the movable section is made of a conductive ceramic material and the support section is constructed by coating a non-conductive material with a non-magnetic and conductive material.

[Mode 9]

In the above described mode 8, the coating is provided by plating.

[Mode 10]

In the above described mode 8, the coating is made up of a layer formed through PVD or CVD.

[Mode 11]

A static pressure bearing apparatus which jets a fluid with a predetermined pressure between a movable section and a support section which axially supports the movable section to make the movable section neutrally float to thereby support the movable section, wherein the movable section and support section are made of a conductive material.

[Mode 12]

A static pressure bearing apparatus which jets a fluid with a predetermined pressure between a movable section and a support section which axially supports the movable section to make the movable section neutrally float to thereby support the movable section, wherein the movable section is made of a conductive ceramic material and the support section is constructed by coating a non-conductive material with a non-magnetic and conductive material.

[Mode 13]

A positioning method characterized by positioning the object at a predetermined position within the predetermined plane using the stage apparatus according to any one of the above described modes 1 to 10.

[Mode 14]

An exposure apparatus characterized by relatively scanning an original plate and base plate using the stage apparatus according to any one of the above described modes 1 to 10 and causing the pattern on the original plate to be exposed to light on the base plate.

[Mode 15]

A method for manufacturing a device comprising the step of manufacturing a semiconductor device using the exposure apparatus according to the above described mode 14.

According to the above described modes, the present invention can be used in a high degree of vacuum so as to be adaptable to an electron beam exposure apparatus, etc., and can implement a high precision and non-magnetic stage apparatus at low cost.

Furthermore, using a conductive material as the material (movable section and support section) of the static pressure bearing which axially supports the stage of an electron beam drawing apparatus, etc., used in a high degree of vacuum in a movable manner makes it possible to omit steps such as plating and improve reliability.

Furthermore, using a ceramic material (silicon carbide, alumina prepared so as to have conductivity or composite material with silicon immersed in porous silicon carbide) as the above described conductive material makes it possible to keep the strength of the movable section and support section and construction with a ceramic material can provide sufficiently high surface hardness and reduce damages of the guide at the time of contact.

Furthermore, setting the volume resistance value to approximately 1E⁻³ Ω·cm or more makes it possible to reduce beam shifts through the influences of eddy current and charging.

Furthermore, using non-magnetic substance for the conductive material can provide an optimal static pressure bearing for an electron beam drawing apparatus, etc.

Furthermore, according to the above described modes, using a conductive material for the movable section requiring the accuracy and rigidity of the static pressure bearing which axially supports the stage of the electron beam drawing apparatus, etc., used in a high degree of vacuum in a movable manner and using other members which do not require finish machining coated with a conductive material makes it possible to reduce the material cost and manufacturing cost.

Furthermore, using plating (e.g., Kanigen plating, flame spraying of aluminum, etc.) realizes a cost reduction.

Furthermore, coating the surface with a material such as TiC and TiN using CVD or PVD realizes a cost reduction.

Other objects and advantages besides those discussed above shall be apparent to those skilled in the art from the description of a preferred embodiment of the invention which follows. In the description, reference is made to accompanying drawings, which form apart thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a perspective view of a stage apparatus according to a first embodiment of the present invention;

FIG. 2 is a cross-sectional view showing a schematic structure of a static pressure bearing section in the stage apparatus shown in FIG. 1;

FIG. 3 is a schematic view of an electron beam exposure apparatus using the stage apparatus of this embodiment;

FIG. 4 illustrates a flow of manufacturing a micro device; and

FIG. 5 illustrates a wafer process.

### DETAILED DESCRIPTION OF THE PREFERRED EMBODIMENTS

With reference now to the attached drawings, embodiments of the present invention will be explained in detail below.

[Stage Apparatus]

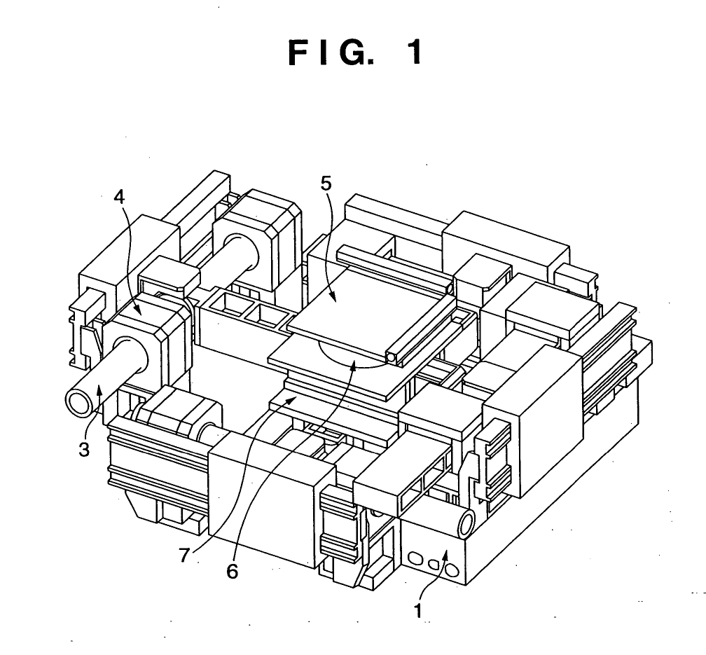

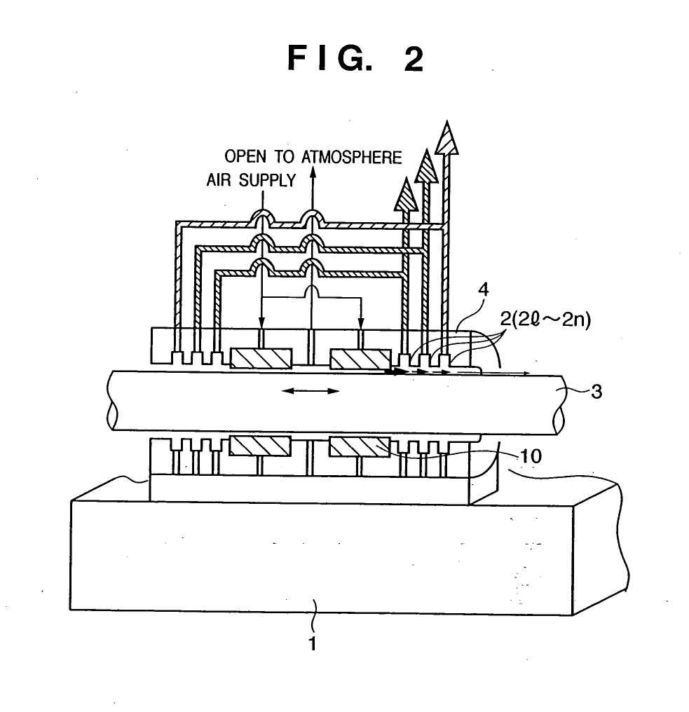

FIG. 1 is a perspective view of a stage apparatus according to a first embodiment of the present invention and FIG. 2 is a cross-sectional view showing a schematic structure of a static pressure bearing section in the stage apparatus shown in FIG. 1.

In FIG. 1 and FIG. 2, reference numeral 1 denotes a base having a reference surface, 10 denotes a static pressure bearing, 2 (21 to 2n) denote gas recovery pockets, 3 denotes a movable guide made of a conductive material, 4 denotes a bearing holding material made of a conductive material or bearing holding material whose surface is covered with the conductive material, 5 denotes a sample holder, 6 denotes a sample mounting mechanism and 7 denotes an XY stage.

In the above described structure, the sample holder 5 holding a sample (not shown) (e.g., a semiconductor wafer) is placed on the sample mounting mechanism 6 and translated within the XY plane by the XY stage 7. The stage apparatus is supposed to be used in a vacuum atmosphere, etc. and the static pressure bearing 10 axially supports the movable guide 3 in a neutral floating state by jetting a gas (or similar fluid) with a predetermined pressure supplied from an external gas supply source (not shown) in the gap with the movable guide 3. The gas jetted from the static pressure bearing 10 is recovered through the gas recovery pockets 2 (21 to 2n) by a vacuum pump (not shown) connected outside the vacuum container.

In the above described structure, using a material having volume resistance of approximately 1E⁻³ Ω·cm or above (e.g., ceramic material provided with conductivity) for the movable guide 3 makes it possible, when used, for example, for an electron beam exposure apparatus, to sufficiently reduce deflection of beams caused by eddy current generated due to a leaked magnetic field from an electronic lens or deflection of beams due to the influences from increased charge by secondary electrons.

Furthermore, in the above described structure, it is also possible to use a ceramic material provided with conductivity (e.g., compact silicon carbide, alumina provided with conductivity, material with silicon immersed in porous silicon carbide) for all materials, or use the conductive ceramic material for only parts requiring precision and rigidity such as the movable guide of the static pressure bearing and use plating (e.g., Kanigen plating, flame spraying of aluminum material, etc.) for other members or coating them with a material such as TiN and Tic, etc., using PVD or CVD. Finish machining is unnecessary for any parts other than the material for the movable guide of the static pressure bearing and it is not necessary to apply plating or additional machining to the coated surface.

[Exposure Apparatus]

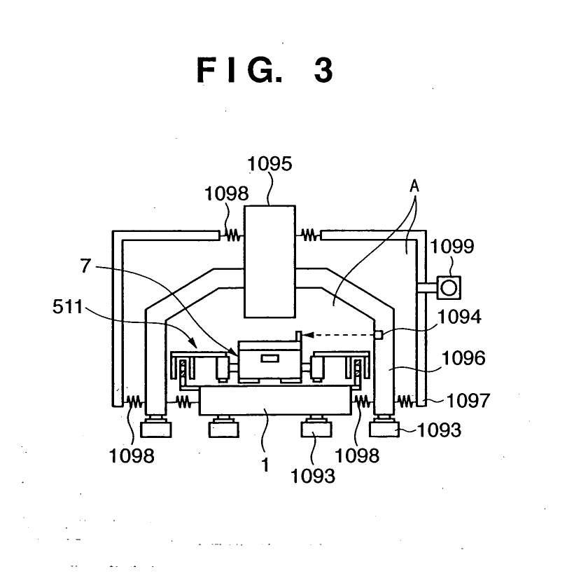

FIG. 3 is a schematic view of an electron beam exposure apparatus using the stage apparatus of this embodiment.

In the same figure, the stage apparatus of the above described embodiment is mounted on an electron beam exposure apparatus which relatively scans a reticule as the original plate and a semiconductor wafer as the base plate and positions them to thereby project a pattern on the original plate onto the base plate through exposure to light.

The stage base 1 is vibration-isolated from the floor through a damper 1093. The damper 1093 may be passive or active. The damper 1093 includes an air spring, etc. and further includes an actuator in the case of an active damper. The position of the XY stage 7 is measured by a laser interferometer 1094 and the XY stage 7 is positioned at a predetermined position within the XY plane based on the result of this position measurement.

Reference numeral 1095 denotes an electronic optical system of the electron beam exposure apparatus. The electronic optical system 1095 is provided with an electron beam irradiation apparatus and an electron lens. The electronic optical system 1095 is supported on a lens barrel base 1096. The lens barrel base 1096 is supported on the damper 1093 and vibration-isolated from the floor. The damper 1093 which supports the lens barrel base 1096 may also be passive or active as with the above described damper. The laser interferometer 1094 which measures the position of the XY stage 7 is provided on the lens barrel base 1096. This allows the XY stage 7 to be positioned relative to the lens barrel base 1096, that is, relative to the electronic optical system 1095.

Reference numeral 1097 denotes a chamber which seals a predetermined area. Here, the predetermined area will be explained later more specifically. Reference numeral 1098 denotes bellows which keeps airtightness and tolerates relative displacement between objects. The bellows 1098 are provided between the chamber 1097 and electronic optical system 1095, between the chamber 1097 and lens barrel base 1096 and between the chamber 1097 and stage base 1. This allows the atmosphere A to be shut off from the outside and sealed. Reference numeral 1099 denotes a vacuum pump. When the vacuum pump 1099 operates, the gas in the atmosphere A in the chamber is exhausted and a vacuum atmosphere is obtained. Here, the vacuum atmosphere is not required to be vacuum in the strict meaning of the word but as described above, it is acceptable if it is at least a highly decompressed atmosphere.

When the atmosphere A inside the chamber 1097 is reduced to a vacuum atmosphere by the vacuum pump 1099, a pressure difference is produced between the inside and outside of the chamber 1097, and therefore the chamber 1097 is deformed. On the other hand, the bellows 1098 are provided between the chamber 1097 and electronic optical system 1095 and the bellows 1098 tolerate relative displacement between the two while keeping airtightness in the chamber 1097. This causes the influences of deformation of the chamber 1097 to be less transmitted to the electronic optical system 1095. Likewise, the bellows 1098 are also provided between the chamber 1097 and lens barrel base 1096, which causes the influences of deformation of the chamber 1097 to be less transmitted to the lens barrel base 1096, preventing the deformation of the chamber from affecting the electronic optical system.

The structure of the above described exposure apparatus causes the atmosphere around the stage apparatus to become a vacuum atmosphere. Furthermore, the surroundings of the static pressure bearing mounted on the stage apparatus also become a vacuum atmosphere. When the surroundings of the static pressure bearing are a vacuum atmosphere, it is necessary to prevent the fluid used for the static pressure bearing from leaking out into the atmosphere. Since the electron beam exposure apparatus according to this embodiment uses the stage apparatus explained in the above described embodiment as the stage apparatus, it is possible to reduce the leakage of the gas from the static pressure bearing into the vacuum atmosphere.

[Device Manufacturing Method]

Then, an embodiment of a method for manufacturing a device using the above described electron beam exposure apparatus will be explained below.

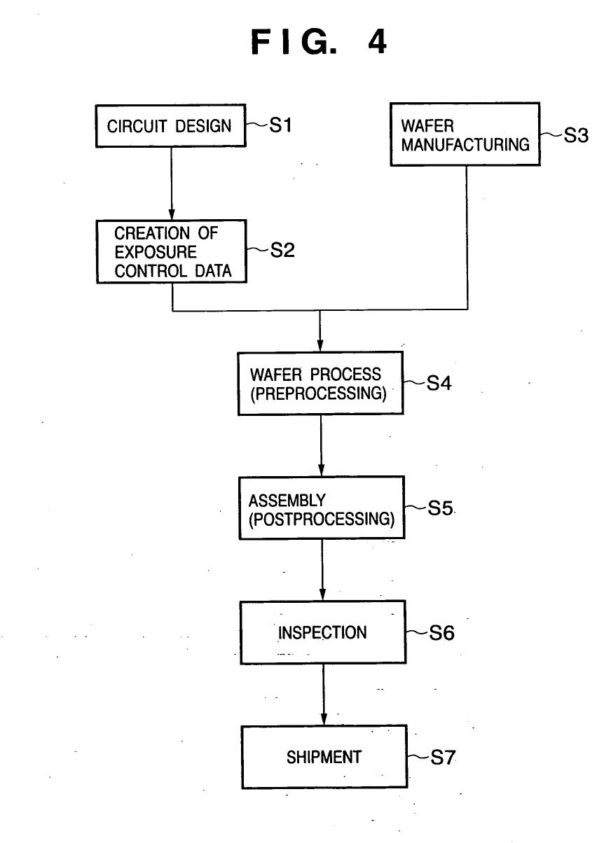

FIG. 4 shows a flow of manufacturing a micro device (semiconductor chip such as IC and LSI, liquid crystal panel, CCD, thin film magnetic head, micro machine, etc.). In step S1 (circuit design), circuit design of a semiconductor device is conducted. In step S2 (creation of exposure control data), exposure control data of an exposure apparatus is created based on the designed circuit pattern. On the other hand, in step S3 (wafer manufacturing), a wafer is manufactured using a material such as silicon. Step S4 (wafer process) is called preprocessing in which an actual circuit is formed on the wafer using the exposure apparatus to which the exposure control data prepared above is input and the wafer according to a lithography technology. The next step S5 (assembly) is called “postprocessing” in which the wafer created in step S4 is transformed into a semiconductor chip and includes assembly process (dicing, bonding), packaging process (chip injection), etc. In step S6 (inspection), the semiconductor device created in step S5 is subjected to various tests such as an operation check test, durability test, etc. Through these processes, the semiconductor device is completed and shipped (step S7).

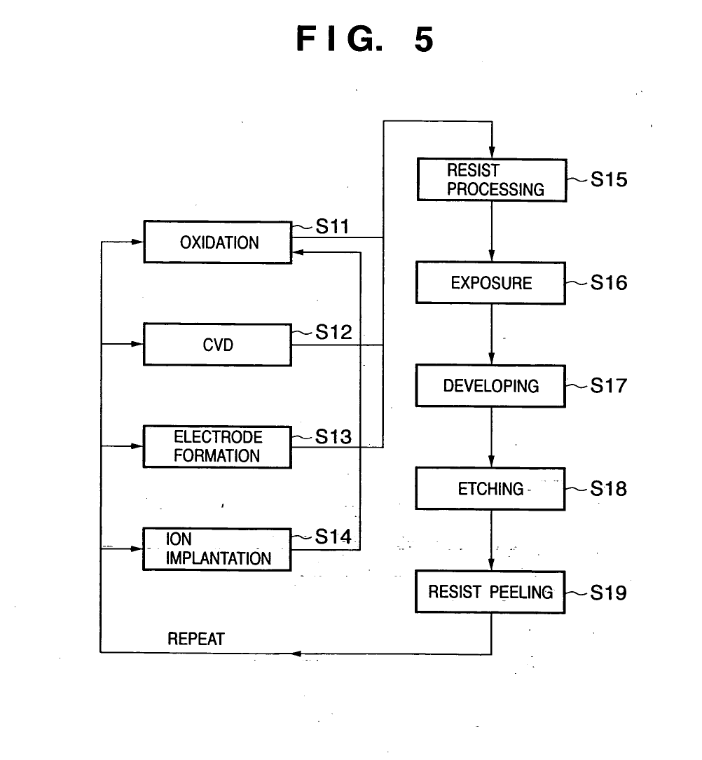

FIG. 5 shows a detailed flow of the above described wafer process. In step S11 (oxidation), the surface of the wafer is oxidized. In step S12 (CVD), an insulating film is formed on the surface of the wafer. In step S13 (electrode formation), electrodes are formed on the wafer through vapor deposition. In step S14 (ion implantation), ions are implanted into the wafer. In step S15 (resist processing), a photosensitive agent is applied to the wafer. In step S16 (exposure), a circuit pattern is printed and exposed to light on the wafer using the above described exposure apparatus. In step S17 (developing), the exposed wafer is developed. In step 18 (etching), parts other than the developed resist image are removed. In step S19 (resist peeling), the unnecessary resist after etching is removed. By repeating theses steps, multilayered circuit patterns are formed on the wafer.

Using the manufacturing method of this embodiment allows a highly integrated semiconductor device to be manufactured at low cost, which has been previously difficult to realize.

The present invention is not limited to the above embodiments and various changes and modifications can be made within the spirit and scope of the present invention. Therefore, to apprise the public of the scope of the present invention the following claims are made.

1. A stage apparatus installed in a predetermined atmosphere, comprising:
a stage provided with a holder which holds an object for moving said holder within a predetermined plane; and
at least one static pressure bearing section which jets a fluid with a predetermined pressure between a movable section which moves said stage within said predetermined plane and a support section which axially supports said movable section to make said movable section neutrally float to thereby support said movable section,
wherein said movable section and support section are made of a conductive material.

2. The stage apparatus according to claim 1, wherein said conductive material is a conductive ceramic material.

3. The stage apparatus according to claim 2, wherein said conductive ceramic material is silicon carbide.

4. The stage apparatus according to claim 2, wherein said conductive ceramic material is alumina prepared so as to have conductivity.

5. The stage apparatus according to claim 2, wherein said conductive ceramic material is a composite material with silicon immersed in porous silicon carbide.

6. The stage apparatus according to claim 1, wherein said conductive material is a material having volume resistivity of at least approximately 10⁻³ Ω·cm.

7. The stage apparatus according to claim 1, wherein said conductive material is non-magnetic substance.

8. A stage apparatus installed in a predetermined atmosphere, comprising:
a stage provided with a holder which holds an object for moving said holder within a predetermined plane; and
at least one static pressure bearing section which jets a fluid with a predetermined pressure between a movable section which moves said stage within said predetermined plane and a support section which axially supports said movable section to make said movable section neutrally float to thereby support said movable section,
wherein said movable section is made of a conductive ceramic material and said support section is constructed by coating a non-conductive material with a non-magnetic and conductive material.

9. The stage apparatus according to claim 8, wherein said coating is provided by plating.

10. The stage apparatus according to claim 8, wherein said coating is made up of a layer formed through PVD or CVD.

11. A static pressure bearing apparatus which jets a fluid with a predetermined pressure between a movable section and a support section to make said movable section neutrally float to thereby support said movable section,
wherein said movable section and support section are made of a conductive material.

12. A static pressure bearing apparatus which jets a fluid with a predetermined pressure between a movable section and a support section to make said movable section neutrally float to thereby support said movable section,
wherein said movable section is made of a conductive ceramic material and said support section is constructed by coating a non-conductive material with a non-magnetic and conductive material.

13. A positioning method for positioning said object at a predetermined position within said predetermined plane using the stage apparatus according to claim 1.

14. An exposure apparatus which relatively scans an original plate and base plate using the stage apparatus according to claim 1 and causes the pattern on said original plate to be exposed to light on said base plate.

15. A method for manufacturing a device comprising the step of manufacturing a semiconductor device using the exposure apparatus according to claim 14.
